(19) United States
(12) Patent Application Publication
(10) Pub. No.: US 2018/0349320 A1
(43) Pub. Date: Dec. 6, 2018

(54) TIME SERIES DATA ANALYSIS DEVICE, TIME SERIES DATA ANALYSIS METHOD, AND COMPUTER PROGRAM

(71) Applicant: KABUSHIKI KAISHA TOSHIBA, Tokyo (JP)

(72) Inventors: Akihiro YAMAGUCHI, Ota Tokyo (JP); Takeichiro NISHIKAWA, Yokohama Kanagawa (JP)

(73) Assignee: KABUSHIKI KAISHA TOSHIBA, Tokyo (JP)

(21) Appl. No.: 15/916,951

(22) Filed: Mar. 9, 2018

(30) Foreign Application Priority Data
Jun. 1, 2017 (JP) 2017-109553

(51) Int. Cl. G06F 17/16; G06F 17/11; G06N 99/00

(52) U.S. Cl. CPC G06F 17/16; G06N 99/005; G06F 17/11

(57) ABSTRACT

According to one embodiment, a time series data analysis device includes a feature vector calculator and an updater. The feature vector calculator calculates feature amounts of a plurality of feature waveforms based on distances between a partial time series and the feature waveforms, the partial time series being data belonging to each of a plurality of intervals which are set in a plurality of pieces of time series data. The updater updates the feature waveforms based on the feature amounts.

### CROSS REFERENCE TO RELATED APPLICATIONS

This application is based upon and claims the benefit of priority from the prior Japanese Patent Application No. 2017-109553, filed on Jun. 1, 2017, the entire contents of which are incorporated herein by reference.

### FIELD

Embodiments described herein relate to a time series data analysis device, a time series data analysis method, and a computer program.

### BACKGROUND

In various kinds of data mining fields such as sensor data analysis and economic time series analysis, the technology of detection anomaly in time series data has been playing an increasingly important role. The anomaly detection technology is required not only to detect anomaly but also to determine the cause of the anomaly. A time series shapelets method (TSS method) has been actively researched as such a technology. The TSS method finds shapelets that are feature waveforms useful for classification.

In the conventional TSS method, partial time series data that matches most with shapelets is specified in time series data, and only the distance between the specified partial time series data and the shapelets is considered. Thus, it is difficult to detect an anomaly waveform at any other place in the time series data. Moreover, most TSS methods employ supervised learning and thus have difficulties in finding unseen anomaly.

### BRIEF DESCRIPTION OF THE DRAWINGS

FIG. 1 is a block diagram of a time series data analysis device according to an embodiment of the present invention;

FIG. 2 is a diagram illustrating an exemplary time series data set T;

FIG. 3 is a diagram illustrating an exemplary feature waveform set S;

FIG. 4 is a diagram illustrating a flowchart of an operation of a feature waveform selector;

FIGS. 5A and 5B are each a diagram illustrating a specific example of the operation of the feature waveform selector;

FIG. 6 is a diagram illustrating exemplary conversion from reliability width vectors to the feature vectors;

FIGS. 7A and 7B are each a diagram schematically illustrating an classification boundary expressed by a learned model parameter;

FIG. 8 is a diagram illustrating a flowchart of an operation in a learning phase;

FIG. 9 is a diagram illustrating exemplary output information;

FIG. 10 is a diagram illustrating other exemplary output information;

FIG. 11 is a diagram illustrating a flowchart of an operation in a test phase;

FIG. 12 is a diagram illustrating a hardware configuration of the time series data analysis device according to the embodiment of the present invention;

FIG. 13 is a diagram illustrating an example in which a plurality of matching ranges are set and a plurality of feature waveforms are specified for each matching range;

FIG. 14 is a diagram illustrating an example in which a plurality of pieces of time series data are connected with each other; and

FIG. 15 is a diagram illustrating a time series data analysis system according to an embodiment of the present invention.

### DETAILED DESCRIPTION

According to one embodiment, a time series data analysis device includes a feature vector calculator and an updater. The feature vector calculator calculates feature amounts of a plurality of feature waveforms based on distances between a partial time series and the feature waveforms, the partial time series being data belonging to each of a plurality of intervals which are set in a plurality of pieces of time series data. The updater updates the feature waveforms based on the feature amounts.

Embodiments of the present invention will be described below with reference to the accompanying drawings.

### First Embodiment

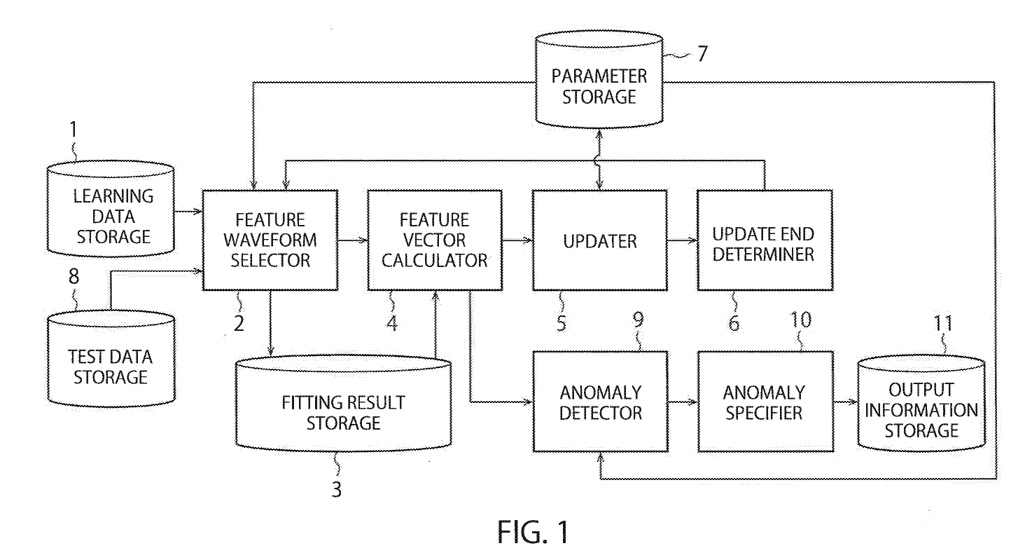

FIG. 1 is a block diagram of time series data analysis device according to an embodiment of the present invention.

The time series data analysis device illustrated in FIG. 1 includes a learning data storage 1, a feature waveform selector 2, a fitting result storage 3, a feature vector calculator 4, an updater 5, an update end determiner 6, a parameter storage 7, a test data storage 8, an anomaly detector 9, an anomaly specifier 10, and an output information storage 11.

The time series data analysis device has a learning phase and a test phase. In the learning phase, a model parameter of a one-class identifier and a plurality of feature waveforms are learned by using learning time series data. In the test phase, time series data as a test target is evaluated by using the model parameter and the feature waveforms learned in the learning phase. In this manner, it is determined whether anomaly has occurred to an analysis target device of the time series data as a test target.

In the learning phase, among the components illustrated in FIG. 1, the learning data storage 1, the feature waveform selector 2, the fitting result storage 3, the feature vector calculator 4, the updater 5, the update end determiner 6, and the parameter storage 7 are used. In the test phase, the test data storage 8, the feature waveform selector 2, the fitting result storage 3, the feature vector calculator 4, the anomaly detector 9, the anomaly specifier 10, and the output information storage 11 are used.

The following description of the present device will be made separately for the learning phase and the test phase.

### Learning Phase

The learning data storage 1 stores learning time series data acquired from a plurality of analysis target devices. The learning time series data is unsupervised time series data. Specifically, the time series data is time series data (normal time series data) acquired from each analysis target device in a normal state. The learning time series data is not labeled to be normal or anomalous. In the present embodiment, time series data is assumed to be time series data of a single variable. Time series data is, for example, time series data based on a detected value of a sensor installed on the analysis target device. Time series data may be a sensed value of a sensor itself, a statistical value (for example, average, maximum, minimum, or standard deviation) of the detected value, or a calculated value of detected values of a plurality of sensors (for example, electrical power as the product of current and voltage). In the following description, a set of pieces of time series data is represented by T, and the number of pieces of time series data is represented by I. The length of each piece of time series data is represented by Q. Specifically, each piece of time series data is data made of Q points.

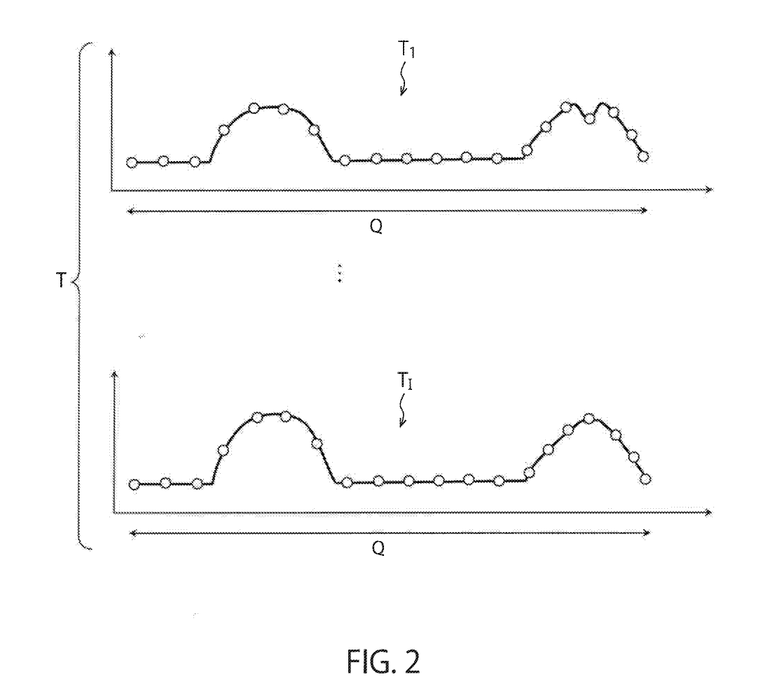

FIG. 2 illustrates an exemplary time series data set T stored in the learning data storage 1. The set T includes I pieces of time series data. The length of each piece of time series data is Q. Thus, each piece of time series data includes Q points. FIG. 2 illustrates an example in which Q points are connected with each other by a line.

An individual piece of time series data is represented by T_{i(i=1, 2, . . . , I)}. An optional piece of time series data is expressed as time series data i. In the present embodiment, the length of each piece of time series data is Q, but the present embodiment is also applicable to a case in which pieces of time series data have different lengths.

The learning data storage 1 stores values indicating the number K of feature waveforms and the length L of each feature waveform. The length L is smaller than the length Q of each piece of time series data.

The feature waveform is data made of L points. When a set of feature waveforms is represented by S, S is a K×L matrix. The feature waveform corresponds to what is called a shapelet in a time series shapelets method (TSS method). As described later, the feature waveform is repeatedly updated once an initial shape is determined at start of the learning phase.

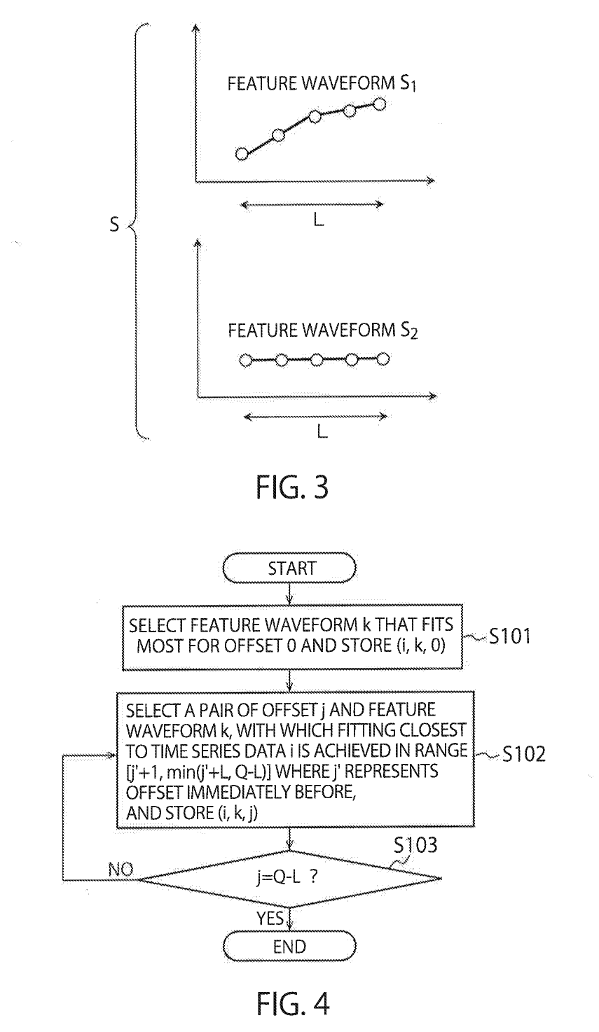

FIG. 3 illustrates an exemplary feature waveform set S of two feature waveforms (K=2). The length of each feature waveform is L. The feature waveforms are denoted by S₁ and S₂. In the present embodiment, the feature waveforms have the same length L, but the present embodiment is also applicable to a case in which the feature waveforms have different lengths.

The following describes a method of calculating the distance between time series data i and a feature waveform k. An offset of the time series data i is represented by j. The offset is a length from the start position (start) of a waveform of time series data. The distance D between the feature waveform k and the time series data i at the offset j (more specifically, the distance D between the feature waveform k and a partial time series in an interval of the length L from the offset j in the time series data i) is calculated as described below. In this example, the Euclidean distance is used, but the present embodiment is not limited thereto. Any kind of distance that allows evaluation of the similarity between waveforms may be used.

$$\begin{matrix}[ Formula 1 ] & \\ {D}_{i , k , j} = \frac{1}{L} {\sum }_{l = 1}^{L} {( {T}_{i , j + i - l} - {S}_{k , l} )}^{2} & ( 1 )\end{matrix}$$

T_{i,j+l-1} represents a value at the (l−1)-th position from the position of the offset j in the time series data i included in the time series data set T. S_{k,l} represents a value at the l-th position from the start of the feature waveform k included in the feature waveform set S. Thus, D_{i,k,j} calculated by Formula (1) corresponds to the average distance between the feature waveform k and the partial time series (partial waveform) in the interval of the length L from the offset j in the time series data i. The partial time series and the feature waveform k are more similar to each other as the average distance is smaller.

The feature waveform selector 2 specifies, by using the K feature waveforms each having the length L, a feature waveform closest (fit most) to a partial time series in each of a plurality of intervals set in the time series data i. The intervals are set to cover the entire range of the time series data i. In a specific operation, the feature waveform selector 2 first selects, from among the K feature waveforms, a feature waveform closest (fit most) to a partial time series in an interval having the length L at the start of the time series data. Subsequently, the feature waveform selector 2 specifies an interval and a feature waveform that achieve a minimum distance from a partial time series in a certain range from an interval that is set immediately before. In the certain range, an interval has no gap from the previous interval. Subsequently, the same operation is repeated. In this manner, a plurality of intervals are set, and a feature waveform having a minimum distance from a partial time series is selected for each interval. When the position of each interval (in the present embodiment, the start position of the interval) is expressed as an offset, a set of pairs of an offset and a feature waveform is generated. In other words, a set of pairs of a feature waveform and an offset is generated to achieve fitting closest to the time series data i in the entire range. Such processing is referred to as fitting processing.

In the first fitting processing, K initial feature waveforms are created and used. After the K feature waveforms are updated by the updater 5 to be described later, the feature waveform selector 2 uses the K feature waveforms updated immediately before.

The processing of generating initial feature waveforms may be performed by any method that generates optional waveform data having the length L. For example, K pieces of random waveform data may be generated. Alternatively, similarly to the related technology, K pieces of waveform data may be generated by applying the k-means method to a plurality of partial time series each having the length L and obtained from the time series data set T.

FIG. 4 illustrates a flowchart of the operation of the feature waveform selector 2.

First, at step S101, the offset j is set to zero. Then, for each time series data i, a feature waveform having the minimum distance D from a partial time series in an interval of the length L from the offset of zero in the time series data i is selected from among K feature waveforms. The selected feature waveform is referred to as the feature waveform k. Through this operation, the set of (i, k, 0) is calculated for the time series data i. The calculated (i, k, 0) and the value of the distance D thus obtained are stored in the fitting result storage 3.

Subsequently, step S102 is performed. The previously selected offset (currently at zero) is represented by j′. A pair of the offset j and the feature waveform k that achieve the minimum distance D from (fit most to) the time series data i are selected within the range of j′+1 to min(j′+L, Q−L). The function of min(j′+L, Q−L) provides the smaller one of j′+L and Q−L. Through this operation, a set of (i, k, j) is obtained for each time series data i. The calculated (i, k, j) and the value of the distance D thus obtained are stored in the fitting result storage 3.

It is determined that the equation j=Q−L is satisfied (step S103), and the operation at step S102 is repeated while the equation j=Q−L is not satisfied (NO). When the equation j=Q−L is satisfied (YES), the repetition ends. The satisfaction of the equation j=Q−L means that processing is completed up to the end of the time series data. In other words, the satisfaction means that a feature waveform is selected for a partial time series in an interval having the length L and including the end of the time series data.

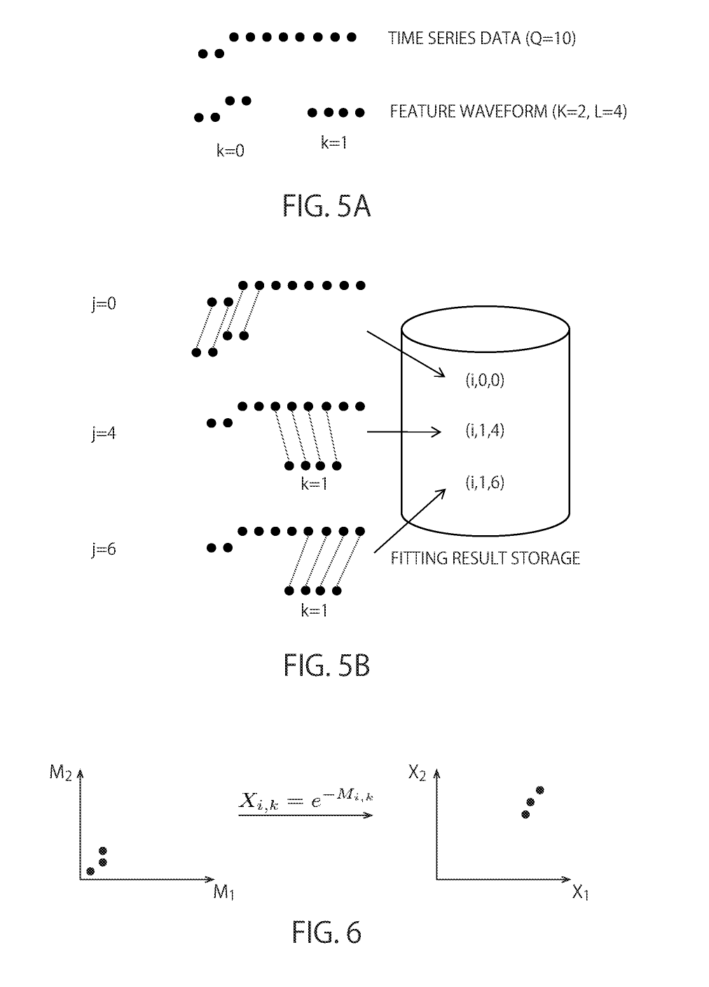

The following describes a specific operation example of the fitting processing with reference to FIGS. 5A and 5B. As illustrated in FIG. 5A, there is the time series data i having the length Q=10. There are two feature waveforms 0 and 1 each having the length L=4.

As illustrated in FIG. 5B, with the offset j=0, the distance from a partial time series in an interval having a length of 4 from the start of the time series data i is calculated for each of the feature waveforms 0 and 1. Assume that the feature waveform 0 is the feature waveform having the smaller distance. Thus, the feature waveform 0 is selected for the offset j=0, and the set of (i, 0, 0) is obtained. The set of (i, 0, 0) is stored in the fitting result storage 3.

Subsequently, among the offsets 1 (=j′+1) to 4 (=j′+L), a pair of the offset j and the feature waveform k that achieve fitting closest to the time series data i are selected. Specifically, among an interval having a length of 4 from the offset 1, an interval having a length of 4 from offset 2, an interval having a length of 4 from offset 3, and an interval having a length of 4 from offset 4, a pair of an interval and the feature waveform k that achieve fitting closest to the time series data i are selected.

First, a pair of the offset j and the feature waveform k that achieve fitting closest (minimum distance) to the time series data i are selected for the offset 1. Similarly, a pair of the offset j and the feature waveform k that achieve fitting closest to the time series data i are selected for each of the offsets 2, 3, and 4. Among these pairs, a pair with which the minimum distance is obtained are finally selected. In the present example, a pair of the offset 4 and the feature waveform 1 is selected. Accordingly, the set of (i, 1, 4) is stored in the fitting result storage 3.

Subsequently, among the offsets 5 (=j′+1) to 8 (=j′+L), a pair of the offset j and the feature waveform k that achieve fitting closest to the time series data i are selected. Similarly to the above-described calculation, a pair of the offset 6 and the feature waveform 1 is selected. Accordingly, the set of (i, 1, 6) is stored in the fitting result storage 3.

Since j has become equal to Q−L=10−4=6, the fitting processing ends.

The feature vector calculator 4 uses the set of (i, k, j) obtained by the fitting processing, when calculating a reliability width M as the maximum distance D from each feature waveform for each time series data i.

The reliability width M_{i,k} of the feature waveform k for the time series data i is calculated based on Formula (2) below.

$$\begin{matrix} [ Formula 2 ] & \\ {M}_{i , k} = \{ \begin{matrix}{min}_{j = 0 , 1 , 2 , … , j} {D}_{i , k , j} & \begin{matrix}if the feature waveform k is not \\ selected for the time series data i\end{matrix} \\ {max}_{{n = 0 , 1 , 2 , … , {N}_{i}}_{k = {k}_{n}}} {D}_{i , {k}_{n} , {j}_{n}} & \begin{matrix}if the feature waveform k is \\ selected for the time series data i\end{matrix}\end{matrix} & ( 2 )\end{matrix}$$

In the formula, n represents the ordinal number of an offset among a plurality of offsets j acquired for the time series data i.

In the formula, Ni represents a value obtained by subtracting one from the number of the offsets j acquired for the time series data i.

jₙ [Formula 3]

represents the value of the n-th offset j among the offsets j acquired for the time series data i.

The reliability width M_{i,k} of the feature waveform k for the time series data i is the longest distance among the distances D for offsets with which the feature waveform k is selected (lower part of Formula (2)).

When there is the feature waveform k that is not selected for the time series data i, the distance from the feature waveform k is calculated for each offset increased from the previous offset by a predetermined value (for example, one) from the start position of the time series data i. Then, the minimum distance among the calculated distances is set to be the reliability width (upper part of Formula (3)). The number J in j=0, 1, 2, . . . , J indicates the ordinal number of the last offset.

In this example, the reliability width of the feature waveform k is the maximum distance among the distances D from a partial time series for offsets with which the feature waveform k is selected, but is not limited thereto. For example, the reliability width may be the standard deviation or average value of the distances D from a partial time series for offsets with which the feature waveform k is selected.

The feature vector calculator 4 calculates a feature amount X_{i,k} based on the calculated reliability width M_{i,k}. For example, the following formula is used.

X_{i,k}=e^{-M}^{_{i,k}} [Formula 4]

Then, the feature amount is calculated for each feature waveform k=1, 2, . . . , K to generate a feature vector Xi=(X_{i,1}, X_{i,2}, . . . , X_{i,k}). The reliability width is a positive real number, and thus, the distance from the origin increases in the space (feature space) of the feature amount as the reliability width decreases. The distance from the origin decreases in the feature space as the reliability width increases. FIG. 6 illustrates exemplary conversion of a reliability width vector including the reliability width M_{i,k} of each feature waveform into the feature vector. A reliability width space is illustrated on the left side in FIG. 6, in which the horizontal axis represents a first component of the reliability width vector and the vertical axis represents a second component thereof. The feature space is illustrated on the right side in FIG. 6, in which the horizontal axis represents a first component of the feature vector and the vertical axis represents a second component thereof. Each space is two dimensional.

The feature waveform k selected for the n-th offset j in the time series data i is represented by:

kₙ [Formula 5]

In this case,

(kₙ, jₙ) [Formula 6]

is defined by Formula (3) below.

(kₙ, jₙ) [Formula 7]

is an expression using n into which (k, j) acquired for the time series data i through the above-described fitting processing is rewritten in accordance with a formula of optimization processing to be described later.

$$\begin{matrix} [ Formula 8 ] & \\ ( {k}_{n} , {j}_{n} ) = \{ \begin{matrix}{argmin}_{k ∈ [ {R}_{k , 0} , {R}_{k , 1} ) , j} \{ {D}_{i , k , j} ; j = 0 \} & ( n = 0 ) \\ {argmin}_{k ∈ [ {R}_{k , 0} , {R}_{k , 1} ) , j} \{ {D}_{i , k , j} ; {j}_{n - 1} < j \leq {j}_{n - 1} + L \} & ( n = 1 , 2 , … , {N}_{i} ) \\ {argmin}_{k ∈ [ {R}_{k , 0} , {R}_{k , 1} ) , j} \{ {D}_{i , k , j} ; j = Q - L \} & ( n = {N}_{i} )\end{matrix} & ( 3 )\end{matrix}$$

In Formula (3), R_{k,0} and R_{k,1} are values defining a range (matching range) in which the feature waveform k is selectable in the time series data. The value R_{k,0} indicates the starting point of the matching range, and the value R_{k,1} indicates the end point of the matching range. In the present embodiment, the feature waveform k is selectable in the entire range of the time series data through the start to end, and thus, R_{k,0} and R_{k,1} defining the matching range are set to be zero and Q, respectively. Like a second embodiment to be described later, a plurality of matching ranges may be set in the time series data, and a plurality of feature waveforms may be specified for the respective matching ranges.

The updater 5 performs unsupervised machine learning by mainly using a one-class identifier. This example assumes a one-class support vector machine (OC-SVM) as the one-class classifier. The updater 5 simultaneously performs learning (update) of a model parameter of the OC-SVM and learning (update) of a feature waveform. The model parameter corresponds to a parameter that defines a classification boundary for determination of normal and anomalous states in the feature space. The feature space is a K-dimensional space spanned by X_{i,k(k=1, 2, . . . , K)}. When the number K of feature waveforms is two, the feature space is a two-dimensional space spanned by X_{i,1} and X_{i,2} (refer to the above-described right side in FIG. 6). The term “one-class” means that only time series data (normal time series data) acquired from an analysis target device in a normal state is used. The OC-SVM is an algorithm for learning a linear or non-linear classification boundary formed by a normal data set, or an identifier configured to perform determination based on the classification boundary.

In the present embodiment, the learning of the model parameter (classification boundary) by the OC-SVM, is performed simultaneously with the learning of a feature waveform. Specifically, these learning processes are formulated as an optimization problem as described below. In the following formula, W represents the model parameter. This optimization problem is solved to obtain the model parameter W and the feature waveform set S (K×L matrix).

$$\begin{matrix}[ Formula 9 ] & \\ {min}_{W , S} \frac{{λ}_{1}}{2} {‖ W ‖}^{2} + \frac{1}{I} {\sum }_{i = 1}^{I} l ( W ; φ ( {X}_{i} ) ) + {λ}_{2} B \\ B = \frac{1}{{Σ}_{i = 1 , 2 , … , I} {N}_{i}} {\sum }_{{i = 1 , 2 , … , I}_{{n = 0 , 1 , … , {N}_{i}}_{i < ( W , φ ( {X}_{i} ) )}}} {D}_{i , {k}_{n} , {j}_{n}} \\ l ( W ; φ ( {X}_{i} ) ) = max \{ 0 , 1 - 〈 W , φ ( {X}_{i} ) 〉 \} \\ {D}_{i , k , j} = \frac{1}{L} {\sum }_{i = 1}^{L} {( {T}_{i , j + l - 1} - {S}_{k , l} )}^{2} \\ {X}_{i , k} = {e}^{- {M}_{i , k}} & ( 4 )\end{matrix}$$

In a case of a linear classification boundary, the number of parameters (weights) of a formula representing the classification boundary is finite (for example, two parameters of an intercept and a gradient in a two-dimensional case), and these parameters can be used as the model parameter W. However, in a case of a non-linear classification boundary, parameters (weights) of a formula representing the classification boundary form an infinite dimensional vector. Thus, instead, a support vector set Sv and a set Sa of contribution rates of support vectors belonging to the set Sv are used as the model parameter W of the classification boundary.

Each support vector is a feature vector that contributes to classification boundary determination. Each contribution rate indicates the degree of contribution of the corresponding support vector to classification boundary determination. A larger absolute value of the contribution rate indicates larger contribution to the determination (when the contribution rate is zero, no contribution is made to classification boundary determination, and thus the corresponding feature vector is not a support vector). The SVM can express a non-linear classification boundary by using a kernel (extended inner product function), a support vector, and the contribution rate thereof.

The following describes symbols used in Formula (4).
Xᵢ represents a feature vector for the time series data i.
λ1 and λ2 are hyperparameters given values in advance.
I(W;ϕ(Xᵢ)) is a hinge loss function. Any loss function other than the hinge loss function is applicable.
<X, Y> represents the inner product of X and Y in a finite or infinite dimension.
ϕ represents mapping in the feature space.

This optimization problem can be efficiently calculated by a stochastic gradient method. Another gradient method such as a steepest descent method is applicable. When F represents an objective function (the top formula of Formula (4)) as an optimization target, the gradient δF/δW with respect to the model parameter W and the gradient δF/δS with respect to the feature waveform set S need to be calculated. This calculation can be performed by using the chain rule as a differential formula as described below.

$$\begin{matrix}[ Formula 10 ] & \\ \frac{\partial F}{\partial W} = \frac{\partial }{\partial W} ( \frac{{λ}_{1}}{2} {‖ W ‖}^{2} + \frac{1}{I} {\sum }_{i = 1}^{I} l ( W ; φ ( {X}_{i} ) ) ) & ( 5 ) \\ \frac{\partial F}{\partial {S}_{k , l}} = \frac{1}{I} {\sum }_{i = 1}^{I} ( \frac{\partial l ( W ; φ ( {X}_{i} ) )}{\partial {X}_{i}} \frac{\partial {X}_{i}}{\partial {M}_{i , k}} \frac{\partial {M}_{i , k}}{\partial {S}_{k , l}} ) + {λ}_{2} \frac{\partial B}{\partial {S}_{k , l}} & ( 6 )\end{matrix}$$

In the above formula, δF/δW is equivalent to calculating the gradient of the model parameter W (classification boundary) of the OC-SVM. The OC-SVM is efficiently calculated by the stochastic gradient method by using an algorithm called Pegasos (Primal Estimated sub-GrAdient SOlver for SVM). The model parameter W can be updated by subtracting, from W, the gradient δF/δW (or a value obtained by multiplying the gradient by a value in accordance with a learning rate or the like).

The gradient δF/δS can be calculated by calculating gradients obtained by disassembling according to the chain rule, as described below.

$$\begin{matrix}[ Formula 11 ] & \\ \frac{\partial {X}_{i}}{\partial {M}_{i , k}} = - {e}^{- {M}_{i , k}} & ( 7 ) \\ \frac{\partial {M}_{i , k}}{\partial {S}_{k , l}} = {\sum }_{j = 1}^{J} \frac{\partial {M}_{i , k}}{\partial {D}_{i , k , j}} \frac{\partial {D}_{i , k , j}}{\partial {D}_{k , l}} = \frac{2}{L} ( {S}_{k , l} - {T}_{i , {j}^{′} + l - 1} ) , \\ {j}^{′} = {argmin}_{j = 1 , 2 , … , J} {D}_{i , k , {j}^{′}} & ( 8 )\end{matrix}$$

Formula (7) can be calculated because of:

X_{i,k}=e^{-M}^{_{i,k}} [Formula 12]

Formula (8) is obtained by calculating δM/δD in a subdifferential manner. S can be updated by subtracting, from S, the gradient δF/δS or a value obtained by multiplying the gradient by a coefficient (for example, a value in accordance with the learning rate).

The calculation of δF/δW and δF/δS and the update of W and S are repeatedly performed until the solution converges.

Calculation of δl(W;ϕ(Xᵢ))/δX differs depending on whether the QC-SVM is linear or non-linear.

### Linear Case

The calculation is performed as described below in a subdifferential manner.

$$\begin{matrix}[ Formula 13 ] & \\ \frac{\partial l ( W ; φ ( {X}_{i} ) )}{\partial {X}_{i}} = - 𝕀 [ 1 < W \cdot {X}_{i} ] W & ( 9 )\end{matrix}$$

### Non-Linear Case

Assuming Gaussian kernel, the calculation is performed by using a kernel trick as described below.

$$\begin{matrix} [ Formula 14 ] & \\ \frac{\partial l ( W ; φ ( {X}_{i} ) )}{\partial {X}_{i}} = - 𝕀 [ 1 < {\sum }_{{i}^{′}} {α}_{{i}^{′}} K ( {X}_{i} , {X}_{{i}^{′}} ) ] 2 γ {\sum }_{{i}^{′}} {α}_{{i}^{′}} ‖ {X}_{i} - {X}_{{i}^{′}} ‖ {e}^{- γ {‖ {X}_{i} - {X}_{{i}^{′}} ‖}^{2}} & ( 10 )\end{matrix}$$

Having updated the feature waveform set S and the model parameter W through the above-described calculation using the gradient method, the updater 5 stores the updated feature waveform set S and the updated model parameter W in the parameter storage 7.

The update end determiner 6 determines whether to end the update of the feature waveform set and the model parameter. Specifically, the update end determiner 6 determines whether an update end condition is satisfied. The update end condition is set based on, for example, the number of times of the update. In this case, the update end determiner 6 determines to end the update when the number of times of the update by the updater 5 reaches at a predetermined number of times. In this manner, a time taken for learning can be set to be within a desired range by setting the update end condition based on the number of times of the update.

When anomalous data is provided at learning, the update end condition may be set based on a prediction accuracy calculated by an evaluation function (to be described later) including the updated model parameter and feature vector. In this case, the update end determiner 6 acquires a plurality of pieces of time series data not used for the learning from the learning data storage 1, and predicts whether the data is normal or anomalous by using an evaluation function including the model parameter and the feature vector of time series data that are updated by the updater 5. The update end determiner 6 determines to end the update when the accuracy rate of a prediction result is equal to or higher than a predetermined value. In this manner, the accuracy of an obtained evaluation function can be improved by setting the update end condition based on the prediction accuracy.

When the update end condition is not satisfied, the feature waveform selector 2 performs again the above-described fitting processing by using the feature waveform set S stored in the parameter storage 7. Accordingly, a set of pairs of a feature waveform and an offset are generated for each time series data i and stored in the fitting result storage 3. The feature vector calculator 4 calculates, for each time series data i, a feature vector including the feature amount of each feature waveform by using information stored in the fitting result storage 3. The updater 5 performs optimization processing of the objective function by using the model parameter W (updated immediately before) in the parameter storage 7 and the calculated feature vector. Accordingly, the feature waveform set S and the model parameter W are updated again. The update end determiner 6 determines whether the update end condition is satisfied. While the update end condition is not satisfied, the series of processing at the feature waveform selector 2, the feature vector calculator 4, and the updater 5 is repeated. When having determined that the update end condition is satisfied, the update end determiner 6 ends the learning phase.

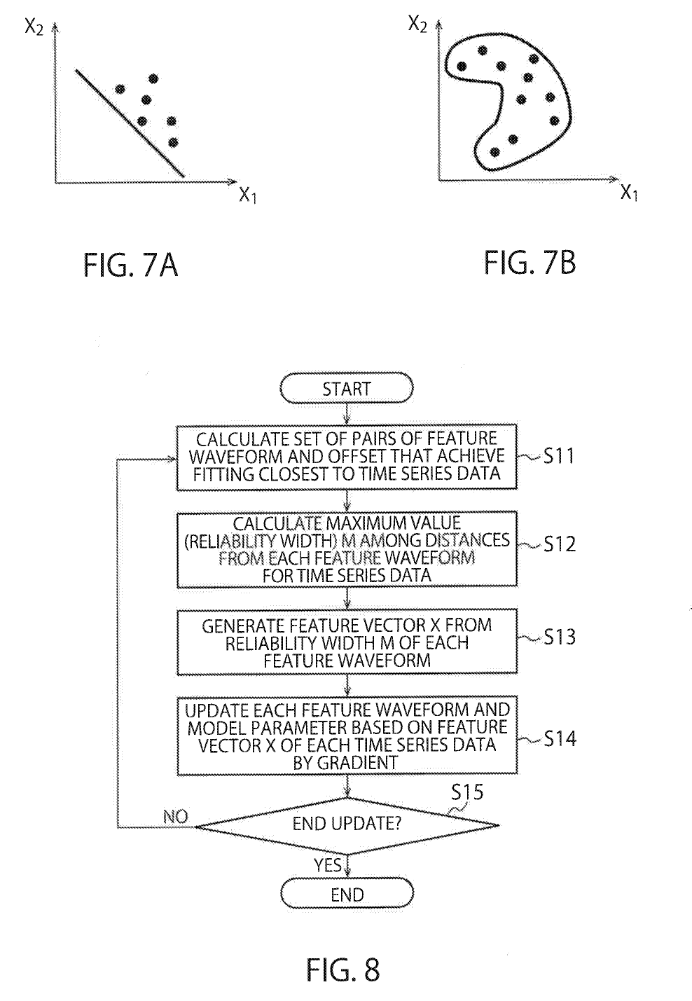

FIGS. 7A and 7B are each a diagram schematically illustrating a classification boundary expressed by learned model parameters. FIG. 7A illustrates an exemplary linear classification boundary, and FIG. 7B illustrates an exemplary non-linear classification boundary. In both cases, the feature space is two-dimensional. As illustrated in FIG. 7A, the linear classification boundary is expressed by a straight line across which a normal region is located on one side and an anomaly region is located on the opposite side. Each black circle indicates a feature vector. At learning, since time series data of the analysis target device in the normal state is used, all feature vectors are disposed in the normal region. As illustrated in FIG. 7B, the non-linear classification boundary has a complicated shape. The normal region is located inside of the classification boundary, and the anomaly region is located outside thereof. All feature vectors are disposed in the normal region.

FIG. 8 is a flowchart of operation in the learning phase.

At step S11, the feature waveform selector 2 reads the time series data i from the learning data storage 1. The feature waveform selector 2 generates a set of pairs of an offset and a feature waveform that achieve fitting closest to the time series data i by using K feature waveforms each having the length L. Specifically, the operation in the flowchart illustrated in FIG. 4 is performed.

At step S12, the feature vector calculator 4 calculates, based on the set (i, k, j) obtained at step S11, the reliability width M as the maximum distance D from each feature waveform for the time series data i. The reliability width M_{i,k} of the feature waveform k for the time series data i is calculated based on Formula (2) described above.

At step S13, the feature vector calculator 4 calculates the feature amount X_{i,k} based on the calculated reliability width M_{i,k} to generate the feature vector Xi=(X_{i,1}, X_{i,2}, . . . , X_{i,k}).

At step S14, the updater 5 updates the model parameter W of a one-class identifier such as the OC-SVM and the set S of K feature waveforms based on the feature vectors of the time series data i by a gradient method such as the stochastic gradient method. Specifically, the updater 5 calculates the gradient of the model parameter W and the gradient of the feature waveform set S and updates the model parameter W and the feature waveform set S based on these gradients. The updater 5 overwrites the updated model parameter W and the updated feature waveform set S to the parameter storage 7.

At step S15, the update end determiner 6 determines whether to end the update of the feature waveform set S and the model parameter W. Specifically, the update end determiner 6 determines whether the update end condition is satisfied. The update end condition can be set based on, for example, the number of times of the update. Steps S11 to S14 are repeated while the update end condition is not satisfied (NO). When the update end condition is satisfied (YES), the learning phase is ended.

### Test Phase

In the test phase, the parameter storage 7, the test data storage 8, the feature waveform selector 2, the fitting result storage 3, the feature vector calculator 4, the anomaly detector 9, the anomaly specifier 10, and the output information storage 11 are used.

The parameter storage 7 stores the updated feature waveform set S and the updated model parameter W that are finally obtained in the learning phase. This example assumes a case in which the support vector set Sv and the contribution rate set Sa are stored as the model parameter W. Each feature waveform included in the updated feature waveform set S corresponds to a second feature waveform according to the present embodiment.

The test data storage 8 stores time series data as a test target. This time series data is based on a detected value of a sensor installed on an analysis target device as a test target.

The feature waveform selector 2 reads the time series data as a test target from the test data storage 8 and performs processing (refer to the flowchart illustrated in FIG. 4) same as that in the learning phase to generate a set of pairs of a feature waveform and an offset that achieve fitting closest to the time series data. The feature waveform set S stored in the parameter storage 7 is used in this processing. The calculated set of pairs of a feature waveform and an offset are stored in the fitting result storage 3.

The feature vector calculator 4 calculates the reliability width M as the maximum distance D from each feature waveform included in the feature waveform set S for the time series data as a test target. The feature vector calculator 4 calculates the feature amount of each feature waveform based on the reliability width M of the feature waveform, and calculates the feature vector X having these feature amounts as elements. These calculations are performed by methods same as those in the learning phase.

The anomaly detector 9 generates an evaluation formula (model) that includes model parameters (Sa and Sv) of a classification boundary and an input variable X and outputs Y, as follows. An anomaly score is defined to be “−Y” obtained by multiplying Y by −1. K represents a kernel function, and Sv represents a set of support vector S′v. Sa represents a set of contribution rates S′a of support vector belonging to Sv. The anomaly detector 9 calculates the evaluation formula by using, as the input variable X, the feature vector X calculated by the feature vector calculator 4.

[Formula 15]

Y=Σ_{(S′}_{ₐ}_{,S′}_{ᵥ}_{)∈(S}_{ₐ}_{,S}_{ᵥ}₎S′ₐK(S′ᵥ, X) (11)

When the calculated anomaly score “−Y” is equal to or larger than a threshold, the anomaly detector 9 detects that anomaly has occurred to the analysis target device. When the anomaly score “−Y” is smaller than the threshold, the anomaly detector 9 determines that no anomaly has occurred to the analysis target device. The threshold is provided in advance.

When anomaly is detected by the anomaly detector 9, the anomaly specifier 10 generates output information related to the detected anomaly. The anomaly specifier 10 stores the generated output information in the output information storage 11.

Specifically, the anomaly specifier 10 specifies an anomaly waveform in the time series data, and generates information identifying the specified anomaly waveform. The following describes a specific operation example. The anomaly specifier 10 calculates, based on each pair of a feature waveform and an offset calculated by the feature waveform selector 2, the distance between a partial time series at this offset and the feature waveform. The calculated distance is compared with the reliability width M of the feature waveform. Any partial time series for which the calculated distance is larger than the reliability width M is determined to be an anomaly waveform. An anomaly waveform may be specified by any method other than the above-described method. The output information may include information on the reliability width of each feature waveform or other information such as a message that notifies detection of anomaly.

The output information stored in the output information storage 11 may be displayed on a display device such as a liquid crystal display device and visually checked by a user such as an anomaly detection operator or administrator. Alternatively, the output information may be transmitted to a user terminal through a communication network. The user can determine when anomaly occurred to which inspection target device by checking information on an anomaly waveform included in the output information. In addition, the user can specify the kind or cause of anomaly by performing, for example, pattern analysis on the anomaly waveform.

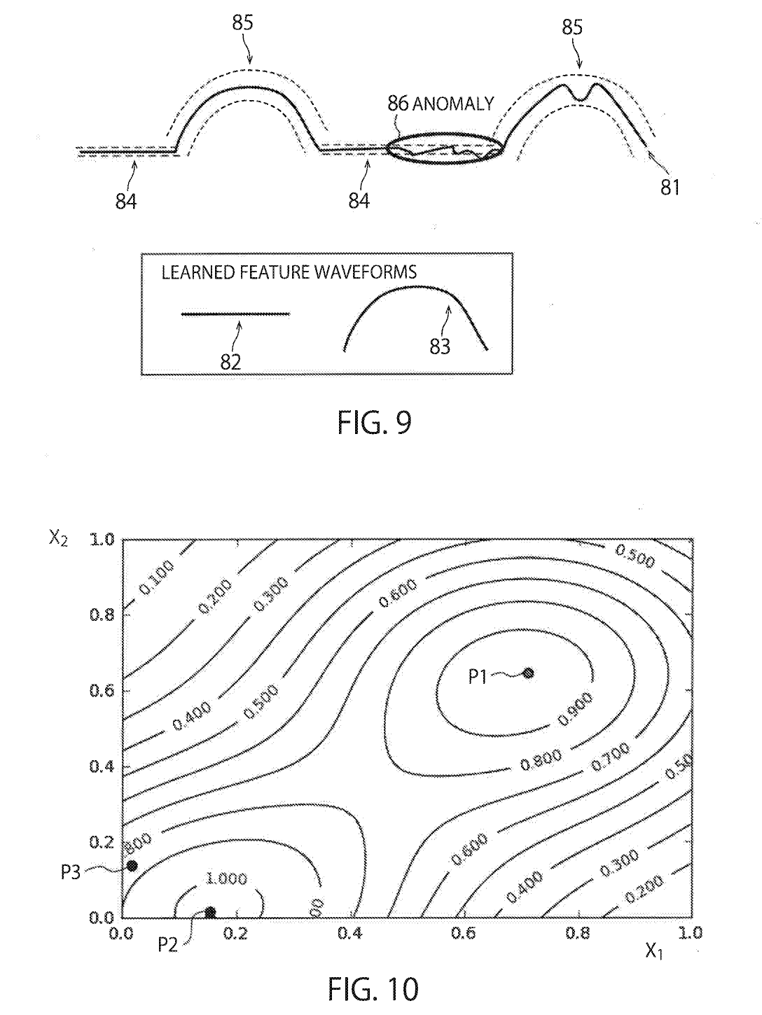

FIGS. 9 and 10 each illustrate exemplary output information.

FIG. 9 illustrates time series data 81 as a test target and two feature waveforms 82 and 83 obtained by learning. In FIG. 9, a pair of dashed lines represents information in accordance with the reliability width of each of the feature waveforms 82 and 83 for a partial time series in an interval for which the feature waveforms are selected. A pair of dashed lines 84 is illustrated on both sides of a partial time series for which the feature waveform 82 is selected, and a pair of dashed lines 85 is illustrated on both sides of a partial time series for which the feature waveform 83 is selected. The width of each pair of dashed lines is smaller for a smaller reliability width M (higher reliability). In this example, a partial time series surrounded by a range 86 is determined to be an anomaly waveform.

In FIG. 10, three feature vectors of time series data as a test target are plotted in the two-dimensional feature space. The horizontal axis represents the first component of the feature vector X and the vertical axis represents the second component thereof. The first component corresponds to the feature amount of a first feature waveform, and the second component corresponds to the feature amount of a second feature waveform. FIG. 10 illustrates points representing these feature vectors P1, P2, and P3. The value of each contour corresponds to Y (obtained by multiplying the anomaly score “−Y” by −1). The contour serves as a classification boundary when a threshold is set. For example, the threshold is set to be 0.9. In this case, such a classification boundary is obtained that the time series data is normal when Y is equal to or larger than 0.9 (when the anomaly score “−Y” is equal to or smaller than −0.9), and anomalous when Y is smaller than 0.9 (when the anomaly score “−Y” is equal to or larger than −0.9). In the example illustrated in FIG. 10, Y is equal to or larger than the threshold of 0.9 for the feature vector P1, and thus the corresponding time series data is determined to be normal. Similarly, Y is equal to or larger than 0.9 for the feature vector P2, and thus the corresponding time series data is determined to be normal. However, Y is smaller than 0.9 for the feature vector P3, and thus the corresponding time series data is determined to be anomalous.

Both pieces of the output information illustrated in FIGS. 9 and 10 may be displayed or only one of them may be displayed.

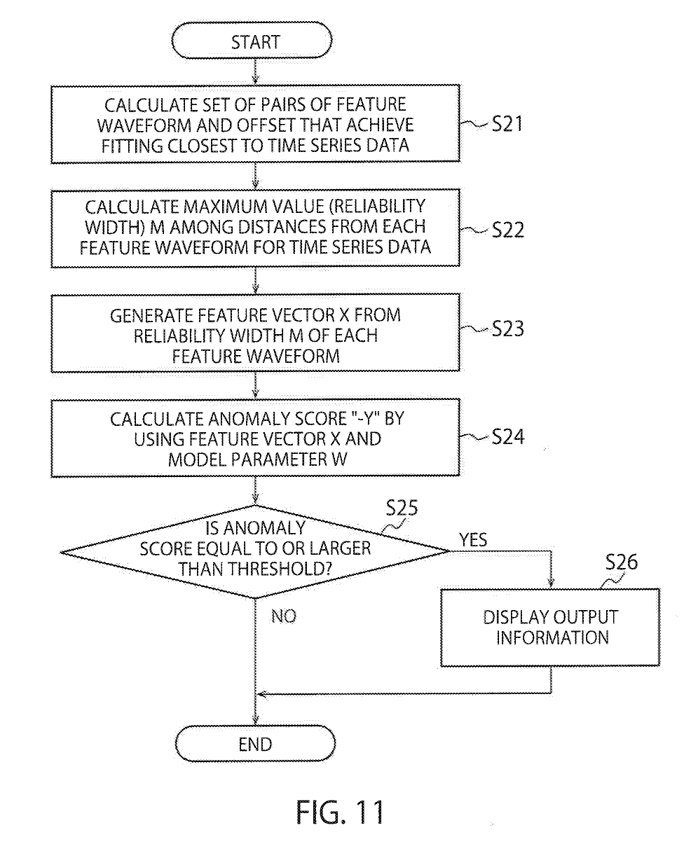

FIG. 11 is a flowchart of operation in the test phase.

At step S21, the feature waveform selector 2 reads time series data as a test target from the test data storage 8, and similarly to step S11 in the learning phase, calculates a set of pairs of a feature waveform and an offset that achieve fitting closest to the time series data. The feature waveform set S stored in the parameter storage 7 is used in this processing.

At step S22, the feature vector calculator 4 calculates the reliability width M as the maximum distance D from each feature waveform included in the feature waveform set S for the time series data as a test target.

At step S23, the feature vector calculator 4 calculates the feature amount of each feature waveform based on the reliability width M of the feature waveform, and generates the feature vector X having these feature amounts as elements.

At step S24, the anomaly detector 9 calculates an evaluation formula (refer to Formula (11)) that includes a model parameter and an input variable X and outputs Y. The feature vector X generated at step S23 is given as the input variable X. The anomaly score “−Y” is calculated by multiplying, by −1, Y calculated by the evaluation formula. The anomaly detector 9 determines whether the anomaly score “−Y” is equal to or larger than a threshold (S25). When the anomaly score “−Y” is smaller than the threshold (NO), the anomaly detector 9 determines an analysis target device to be normal, and ends the test phase. When the anomaly score “−Y” is equal to or larger than the threshold (YES), the anomaly detector 9 detects anomaly of the analysis target device. In this case, the process proceeds to step S26.

At step S26, the anomaly specifier 10 generates output information related to the anomaly detected by the anomaly detector 9. The anomaly specifier 10 outputs a signal representing the generated output information to the display device. The display device displays the output information based on the input signal. The output information includes, for example, information identifying an anomaly waveform specified in time series data. The output information may include information on the reliability width of each feature waveform or other information such as a message notifying detection of anomaly.

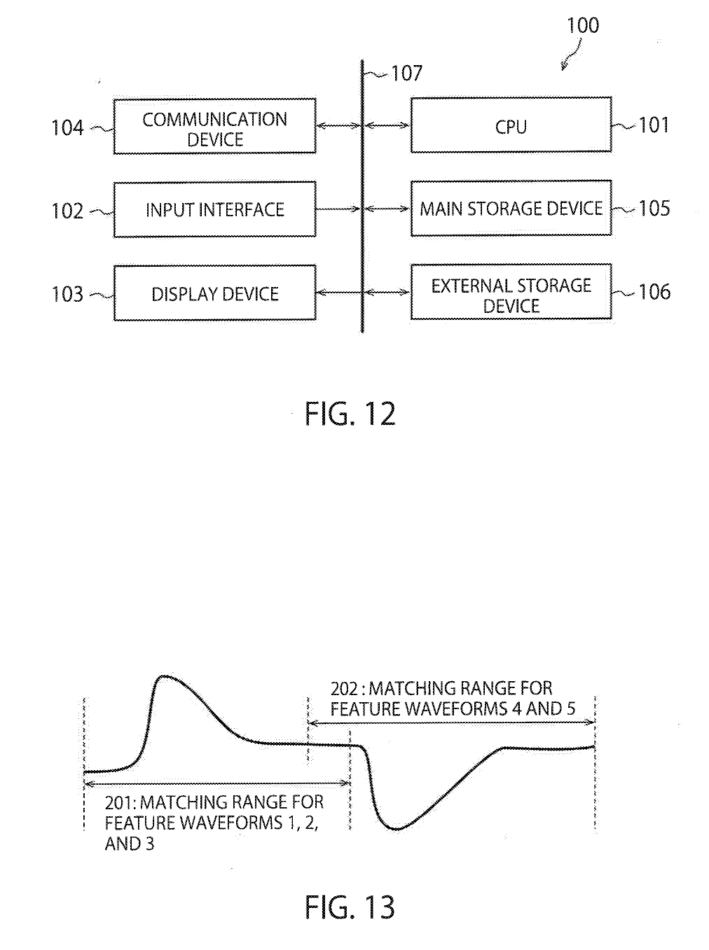

FIG. 12 illustrates a hardware configuration of the time series data analysis device according to the present embodiment. The time series data analysis device according to the present embodiment is configured by a computer device 100. The computer device 100 includes a central processing unit (CPU) 101, an input interface 102, a display device 103, a communication device 104, a main storage device 105, and an external storage device 106. These components are connected with each other through a bus 107.

The CPU 101 executes an analysis program as a computer program on the main storage device 105. The analysis program is a computer program configured to achieve the above-described functional components of the time series data analysis device. The functional components are achieved by the CPU 101 executing the analysis program.

The input interface 102 is a circuit for inputting an operation signal from an input device such as a keyboard, a mouse, or a touch panel to the time series data analysis device.

The display device 103 displays data or information output from the time series data analysis device. The display device 103 is, for example, a liquid crystal display (LCD), a cathode-ray tube (CRT), or a plasma display (PDP), but is not limited thereto. Data or information stored in the output information storage 11 can be displayed by the display device 103.

The communication device 104 is a circuit that allows the time series data analysis device to communicate with an external device in a wireless or wired manner. Data such as learning data or test data can be input from the external device through the communication device 104. The data input from the external device can be stored in the learning data storage 1 or the test data storage 8.

The main storage device 105 stores, for example, the analysis program, data necessary for execution of the analysis program, and data generated through execution of the analysis program. The analysis program is loaded onto the main storage device 105 and executed. The main storage device 105 is, for example, a RAM, a DRAM, or an SRAM, but is not limited thereto. The learning data storage 1, the test data storage 8, the fitting result storage 3, the parameter storage 7, and the output information storage 11 may be constructed on the main storage device 105.

The external storage device 106 stores, for example, the analysis program, data necessary for execution of the analysis program, and data generated through execution of the analysis program. These computer program and data are read onto the main storage device 105 when the analysis program is executed. The external storage device 106 is, for example, a hard disk, an optical disk, a flash memory, or a magnetic tape, but is not limited thereto. The learning data storage 1, the test data storage 8, the fitting result storage 3, the parameter storage 7, and the output information storage 11 may be constructed on the external storage device 106.

The analysis program may be installed on the computer device 100 in advance or may be stored in a storage medium such as a CD-ROM. The analysis program may be uploaded on the Internet.

In the present embodiment, the time series data analysis device is configured to perform both of the learning phase and the test phase, but may be configured to operate in only one of the phases. In other words, a device configured to perform the learning phase and a device configured to perform the test phase may be separately provided.

As described above, in the present embodiment, a model parameter (classification boundary) is learned by using a one-class identifier such as an OC-SVM. In this manner, the model parameter (classification boundary) and feature waveforms can be learned by using only normal time series data. In addition, a non-linear classification boundary can be learned by using a kernel trick. In the related technology, a linear classification boundary is learned by using supervised time series data and logistic regression. In the present embodiment, however, no supervised time series data is needed, and a classification boundary to be learned is not limited to a linear classification boundary but also includes a non-linear classification boundary.

In the present embodiment, an anomaly waveform at an optional position in time series data can be detected. In the related technology, a partial time series that matches most with a feature waveform is specified in the time series data, and only the distance between the specified partial time series and the feature waveform are considered in identifier learning. Thus, anomaly cannot be detected when an anomaly waveform occurs to a partial time series other than the specified partial time series. In the present embodiment, however, a feature waveform that matches most with partial time series in a plurality of intervals set to cover the entire time series data is selected, and the distance between the partial time series in each interval and the selected feature waveform is considered in identifier learning. Thus, anomaly can be detected when an anomaly waveform occurs at an optional position in the time series data.

### Second Embodiment

In the first embodiment, a plurality of common feature waveforms are used for the entire range of time series data in the learning phase. In the second embodiment, however, a plurality of ranges (referred to as matching ranges) are set in the time series data, and a plurality of feature waveforms are prepared for each matching range. In the setting of matching ranges, the time series data may include a place where no matching range is set. The matching ranges may partially overlap with each other. In the learning phase, a plurality of feature waveforms prepared for each matching ranges are used. The setting of matching ranges and specification of a plurality of feature waveforms may be performed by the feature waveform selector 2 or another processing unit (for example, a preprocessing unit provided upstream of the feature waveform selector 2) based on an instruction input through a user interface.

In Formula (3) described above, R_{k,0} and R_{k,1} are values specifying a matching range for the feature waveform k. R_{k,0} and R_{k,1} may be set to be values indicating the starting and end points, respectively, of the matching range. In this manner, a range to be used by each feature waveform in the fitting processing is specified.

FIG. 13 illustrates an example in which a plurality of matching ranges are set and a plurality of feature waveforms are specified for each matching range in the present embodiment. Two matching ranges 201 and 202 are specified in time series data. The matching ranges 201 and 202 partially overlap with each other. Feature waveforms 1, 2, and 3 are set for the matching range 201, and feature waveforms 4 and 5 are set for the matching range 202. In the learning phase, the feature waveform set S in the matching range 201 includes the feature waveforms 1, 2, and 3, and the feature waveform set S in the matching range 202 includes the feature waveforms 4 and 5. In the test phase, the updated feature waveforms 1, 2, and 3 are used in the matching range 201, and the updated feature waveforms 4 and 5 are used in the matching range 202. Thus, in any of the learning phase and the test phase, in the matching range 201, a feature waveform having a minimum distance from a partial time series in an interval (at an offset) belonging to the range 201 is selected from among the feature waveforms 1, 2, and 3. In the matching range 202, a feature waveform having a minimum distance from a partial time series in an interval (at an offset) belonging to the range 202 is selected from among the feature waveforms 4 and 5.

According to the present embodiment, a plurality of feature waveforms can be specified for each of a plurality of matching ranges in time series data.

### Third Embodiment

In the first and second embodiments, time series data of one variable is assumed. In a third embodiment, however, multivariable time series data of a plurality of variables is assumed.

In the present embodiment, a single piece of time series data is generated by connecting pieces of time series data of variables in a temporally sequential manner. Processing same as that of the second embodiment is applied to the generated single time series data.

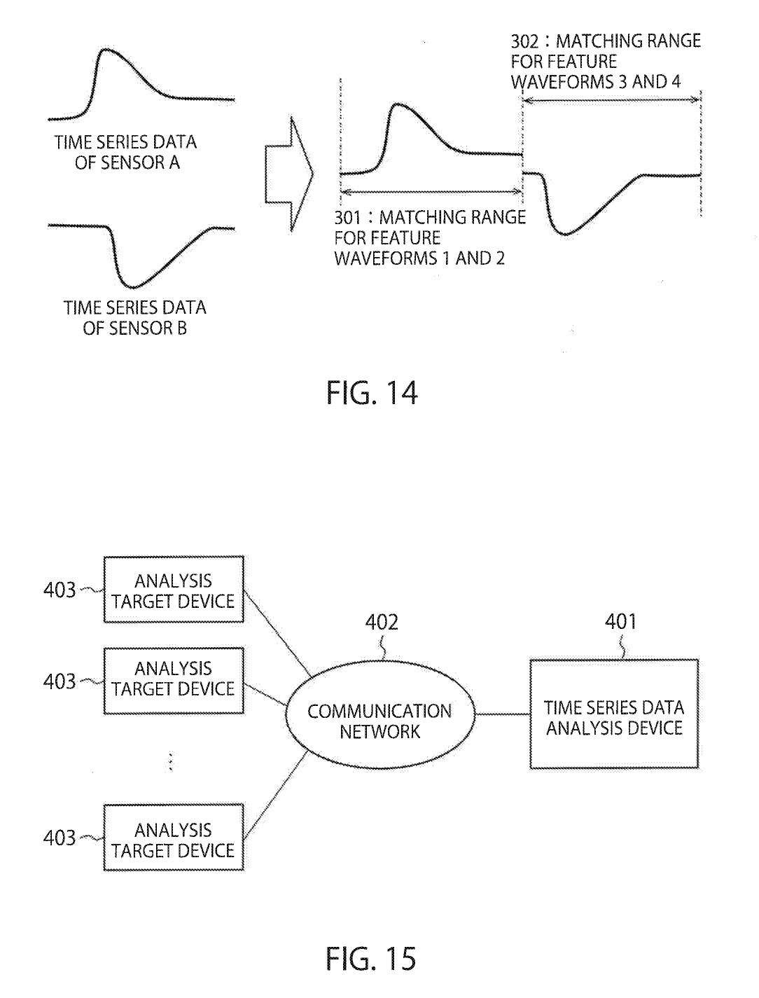

FIG. 14 illustrates an example in which the end of time series data of a variable A corresponding to a sensor A is connected with time series data of a variable B corresponding to a sensor B.

Similarly to the second embodiment, among the connected pieces of time series data, a matching range 301 is set to a time series data part of the variable A, and a matching range 302 is set to a time series data part of the variable B. Feature waveforms 1 and 2 are set in the matching range 301, and feature waveforms 3 and 4 are set in a matching range 302. In the learning phase, the feature waveform set S in the matching range 301 includes the feature waveforms 1 and 2, and the feature waveform set S in the matching range 302 includes the feature waveforms 3 and 4. In the test phase, the updated feature waveforms 1 and 2 are used in the matching range 301, and the updated feature waveforms 3 and 4 are used in the matching range 302. Thus, in any of the learning phase and the test phase, in the matching range 301, a feature waveform having a minimum distance from a partial time series in an interval (at an offset) belonging to the range 301 is selected from among the feature waveforms 1 and 2. In the matching range 302, a feature waveform having a minimum distance from a partial time series in an interval (at an offset) belonging to the range 302 is selected from among the feature waveforms 1 and 2.

According to the present embodiment, feature waveforms corresponding to a plurality of variables can be learned with the relation between the variables taken into account.

### Fourth Embodiment

A fourth embodiment is an embodiment of a time series data analysis system in which the time series data analysis device is connected with an analysis target device through a communication network.

FIG. 15 illustrates the time series data analysis system according to the present embodiment. A time series data analysis device 401 corresponds to the time series data analysis device according to any one of the first to third embodiments. The time series data analysis device 401 is connected with a plurality of analysis target devices 403 through a communication network 402. Each analysis target device 403 includes a sensor configured to detect a physical quantity. The analysis target device 403 generates time series data based on a detected value of the sensor, and transmits the generated time series data to the time series data analysis device 401 through the communication network 402. When collecting time series data for the learning phase, the time series data analysis device 401 checks that each analysis target device 403 is in a normal state in advance. The time series data analysis device 401 stores, in a learning data storage, the time series data received from the analysis target device 403 in the normal state. When collecting time series data for the test phase, the time series data analysis device 401 stores the received time series data in the test data storage 8 and executes the test phase. Accordingly, anomaly of the analysis target device 403 in real time can be tested.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A time series data analysis device comprising:
a feature vector calculator configured to calculate feature amounts of a plurality of feature waveforms based on distances between a partial time series and the feature waveforms, the partial time series being data belonging to each of a plurality of intervals which are set in a plurality of pieces of time series data; and
an updater configured to update the feature waveforms based on the feature amounts.

2. The time series data analysis device according to claim 1, wherein a set of the intervals entirely covers the time series data.

3. The time series data analysis device according to claim 1, further comprising a feature waveform selector configured to set the intervals by repeatedly specifying a pair of an interval and any one of the feature waveforms in a certain range from an interval that is set immediately before, the pair achieving a minimum distance between the any one of the feature waveforms and a partial time series in the interval of the pair.

4. The time series data analysis device according to claim 1, wherein the feature vector calculator specifies a plurality of the partial time series having a minimum distance with any one of the feature wave forms and calculates a feature amount of the any one of the feature waveforms based on a maximum distance among distances between the any one of the feature wave forms and the plurality of the partial time series.

5. The time series data analysis device according to claim 1, wherein the updater calculates gradients of the feature waveforms and updates the feature waveforms based on the gradients.

6. The time series data analysis device according to claim 1, wherein the updater updates a model parameter of a one-class identifier based on the feature amounts by a gradient method.

7. The time series data analysis device according to claim 6, wherein the one-class identifier is an evaluation formula which includes input variables representing the feature amounts and the model parameter.

8. The time series data analysis device according to claim 6, wherein the one-class identifier is a linear or non-linear one-class SVM.

9. The time series data analysis device according to claim 6, further comprising an anomaly detector, wherein
the feature vector calculator calculates feature amounts of a plurality of second feature waveforms as the updated feature waveforms based on distances between a partial time series in each of a plurality of intervals set in time series data as a test target and the second feature waveforms, and
the anomaly detector determines whether the time series data as a test target has anomaly based on the model parameter and the feature amounts of the second feature waveforms.

10. The time series data analysis device according to claim 9, wherein
the feature vector calculator specifies a plurality of the partial time series having a minimum distance with any one of the second feature waveforms and calculates a feature amount of the any one of second feature waveforms based on a maximum distance among distances between the any one of the second feature waveforms and the plurality of the partial time series, and
the time series data analysis device further includes an anomaly specifier configured to specify, when the anomaly is detected in the time series data as a test target, a distance between the partial time series in each interval in the time series data as a test target and the second feature waveform having the minimum distance from the partial time series among the second feature waveforms, compare the specified distance with the maximum distance of the second feature waveform, and determine the partial time series for which the distance is larger than the maximum distance to be an anomaly waveform.

11. The time series data analysis device according to claim 1, wherein
a plurality of ranges are set in the time series data,
a plurality of feature waveforms are specified in the ranges, and
the feature vector calculator calculates the feature amounts based on a minimum distance between the partial time series in each interval and one of a plurality of feature waveforms specified in the range to which each interval belongs.

12. The time series data analysis device according to claim 11, wherein
the time series data is obtained by connecting pieces of time series data of variables in a temporal direction, and
the feature waveforms are specified per each of ranges corresponding to the piece of time series data of the variables.

13. A time series data analysis method comprising:
calculating feature amounts of a plurality of feature waveforms based on distances between a partial time series and the feature waveforms, the partial time series being data belonging to each of a plurality of intervals which are set in a plurality of pieces of time series data; and
updating the feature waveforms based on the feature amounts.

14. A non-transitory computer readable medium having a computer program stored therein which causes a computer to perform processes comprising:
calculating feature amounts of a plurality of feature waveforms based on distances between a partial time series and the feature waveforms, the partial time series being data belonging to each of a plurality of intervals which are set in a plurality of pieces of time series data; and
updating the feature waveforms based on the feature amounts.
